(19) United States
(12) Patent Application Publication
(10) Pub. No.: US 2014/0032275 A1
(43) Pub. Date: Jan. 30, 2014

(54) SYSTEM AND METHOD FOR IMPROVED APP DISTRIBUTION

(71) Applicants: Kenneth J. KALB, Solana Beach, CA (US); Mark H. SCHWARTZ, Livonia, MI (US); Thomas H. BUSCHER, Los Angeles, CA (US)

(72) Inventors: Kenneth J. KALB, Solana Beach, CA (US); Mark H. SCHWARTZ, Livonia, MI (US); Thomas H. BUSCHER, Los Angeles, CA (US)

(21) Appl. No.: 14/041,948

(22) Filed: Sep. 30, 2013

Related U.S. Application Data
(63) Continuation-in-part of application No. 13/231,914, filed on Sep. 13, 2011.
Application No. 13/231,914 is a continuation-in-part of application No. 12/009,280, filed on Jan. 17, 2008, now Pat. No. 8,090,613.

(51) Int. Cl. G06Q 30/02

(52) U.S. Cl. CPC G06Q 30/0257
USPC 705/7.35; 705/14.55

(57) ABSTRACT

The system provides a method and apparatus for improving the adoption of apps. The system provides a method of allowing a downloadable App to be associated with a distributed offer such as a daily deal The offer is distributed to a plurality of publishers but each publisher includes the App download capability with the offer so that any consumer who purchases the offer must download the App as part of the transaction. The system provides metadata and tags for each publisher and publishing platform so allocation of compensation can be accurately made based on from which platform the App was downloaded. The system increases the exposure of the App to a greater number of customers than would otherwise be possible.

### RELATED APPLICATIONS

This patent application is a continuation-in-part of U.S. patent application Ser. No. 13/231,914 filed Sep. 13, 2011 which is a continuation-in-part of U.S. patent application Ser. No. 12/009,280 filed on Jan. 17, 2008 (now U.S. Pat. No. 8,090,613), all of which are incorporated by reference herein in their entirety.

### BACKGROUND OF THE SYSTEM

The increased use of smart-phones, pad computing devices, tablet computers, and the like have created a market for so called “Apps”. An App (also referred to as a “Mobile App”) that is designed to run on a smartphone, tablet, or other mobile device. Apps may be paid Apps or free Apps. Each operating system associated with smartphones and mobile devices typically has its own App distribution system, often referred to as an “App Store”. Apple sells and distributes Apps through its iTunes online distribution platform. Android based devices use the ‘Play Store” to distribute Apps. In addition, there are many web sites who provide the ability to download associated Apps, either through direct download or a link to an associated distribution system.

Many merchants and others have begun developing Apps as a way to increase customer participation and loyalty. The Apps can be used to make it easier for the consumer to access the merchant's products and/or services. Even when free, it is often difficult to achieve a high penetration rate and consumer adoption rate. Many App providers rely on word-of-mouth, media mentions, or advertising to increase the likelihood of App adoption. However, these approaches have the disadvantages of cost, low success rate, and lack of involvement by the merchant or App developer.

### SUMMARY OF THE SYSTEM

The system provides a method and apparatus for improving the adoption of apps. The system provides a method of allowing a downloadable App to be associated with a distributed offer such as a daily deal The offer is distributed to a plurality of publishers but each publisher includes the App download capability with the offer so that any consumer who purchases the offer must download the App as part of the transaction. The system provides metadata and tags for each publisher and publishing platform so allocation of compensation can be accurately made based on from which platform the App was downloaded. The system increases the exposure of the App to a greater number of customers than would otherwise be possible.

### BRIEF DESCRIPTION OF THE DRAWINGS

The drawings described herein are for illustration purposes only and are not intended to limit the scope of the present disclosure in any way.

FIG. 1 illustrates an embodiment of the syndication network.

FIG. 2 illustrates an embodiment of an accountable campaign system.

FIG. 3 is a flow diagram illustrating an offer made to the syndication network with attached media spend in an embodiment of the system.

FIG. 4 is a flow diagram illustrating the selection of an offer with attached media spend from the syndication network in an embodiment of the system.

FIG. 5 is an example computer environment for implementing the system.

FIG. 6 is a flow diagram illustrating automated attachment of media spend in one embodiment of the system.

### DETAILED DESCRIPTION OF THE SYSTEM

The following description is merely exemplary in nature and is not intended to limit the present disclosure, application, or uses. It should be understood that throughout the drawings, corresponding reference numerals indicate like or corresponding parts and features.

The system can be advantageous to publishers, to creators of downloadable apps, to merchants, to financial institutions, to credit card companies, to manufacturers who are making products which they need to promote, to vendors who need to advertise their products or services, and any advertising body, either for a department within a large corporation, or a standalone advertising agency creating campaigns for a multitude of disparate clients companies. These organizations are highly motivated to achieve return on their financial investment in marketing and advertising. Their advertising spending therefore needs to be evaluated in terms of its impact on customer acquisition. The impact thus measured will then allow quantitative measurement of the performance of each advertisement and make it possible based on this information to maximize logistical and economic efficiencies of the overall campaign. These organizations also have a strong desire to acquire customers.

In addition, such entities are looking for new sources of revenue streams. Such entities may have a large network of customers and users that already use the company's services or products. One way to grow revenue is to add customers and users. Another way is to add products. Still another way is to partner with others to offer third party products and services to the network of customers and users.

The system provides a method of improving the distribution of Apps to a greater number of users, taking advantage of the resources of publishers and companies. In addition, the system increases the coversion rate of users to download the App and become registered users.

In one embodiment, the system utilizes a network in which offering publishers provide an offer, such as a Daily Deal, to users, either through direct contact (e.g. direct email, direct mailing, and the like) or indirectly, through advertising, both off-line and on-line. In the system, an App is associated with such an offer, thereby exposing the App to a greater number of possible users, and improving the conversion rate.

In exchange for including the App as either the principal, or a supplemental portion of an offer, the offering publisher shares in revenue generated by the App, or is compensated based on some other metric, such as downloads and registrations.

In some cases, the system is implemented in a publishing syndicate where the offer can be published by a plurality of offering publishers. In another embodiment, only one offering publisher is involved in the distribution of the offer and associated App.

In the example of a publishing syndicate, an “offering publisher” introduces an offer to the syndicate. One or more “receiving publishers” accept the offer and publish it on one or more of their publishing platforms. The offer contemplates a consumer or customer response, and in particular, an election to download the App. In some circumstances, the offer itself may require the use of the App for fulfillment.

For example, a merchant may offer a discount or some other premium to be part of a daily deal offer. But to redeem the offer, the customer must use a merchant App. The App can be associated with the offer if made online, or an offline offer can include instructions as to where to access the App. For customers who have already downloaded the App, the access to the benefit of the offer can be easily accomplished by invoking the App. Again, links or instructions can be provided to those users who already have the App for redeeming the offer.

The response to the offer may be a purchase, a request for information, a website visit, or some other response, including downloading App software. The consumer can respond using smartphones, PDA's tablet and pad based computing devices, Google Glass, telephones, browser enabled devices, and the like. When a consumer responds, the system tallies that response and uses it to analyze the effectiveness of the offer. The system collects all the information that is available in the response from the consumer, including the timing of the response, the avenue of the response, the on-line or off-line format from which the response was generated, and, where available, registered user information. As noted above, the system may be implemented in a system where responders are (or become upon responding) registered users, or it can be implemented where none of the responders are registered users, or it can be a hybrid of registered and unregistered users.

In one embodiment, the system is implemented for both on-line and off-line environments. Any syndicate member may have off-line and/or on-line capabilities in a combined system. In other embodiments, the system may be implemented exclusively on-line or exclusively off-line.

One of the advantages of the system is the use of analytics to provide accountability for each ad or deal or offer implemented using the system. This provides the data to drive metrics associated with the offers and even the publishers so that intelligent and automated decisions may be made regarding syndication of offers and sharing of revenue.

Another advantage of the system is the tracking of metadata associated with the downloading and use of the App, so that appropriate compensation can be determined for the offering publisher.

Network Syndicate Structure

In one embodiment, the system contemplates a network of publishers in a network syndicate, where the publishers participate in a shared campaign management system. The following is an example of such a network syndicate.

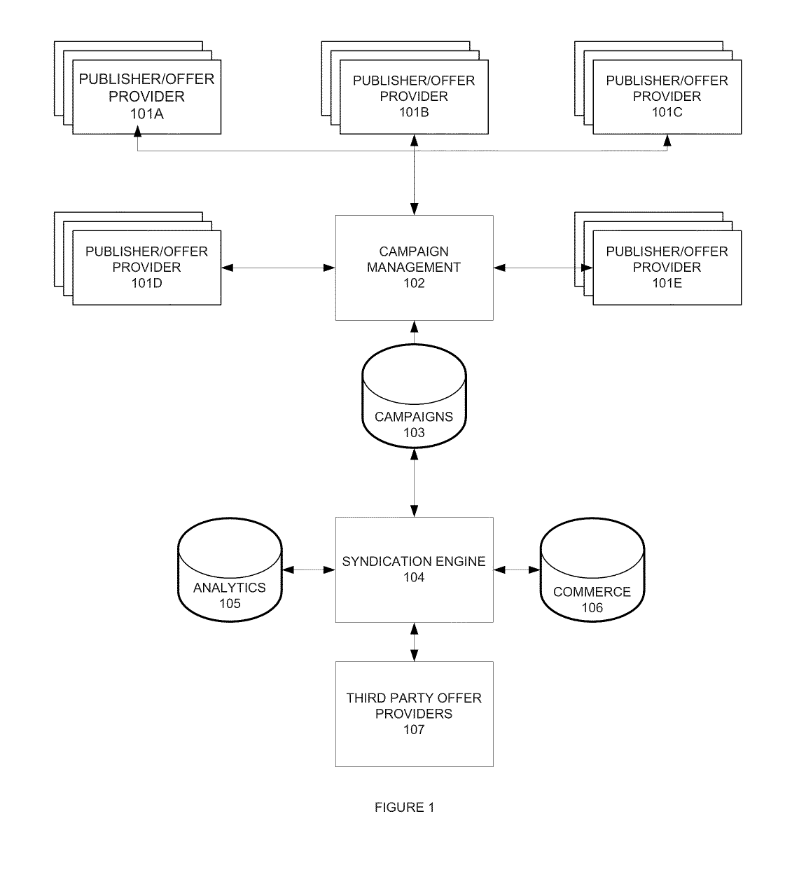

FIG. 1 illustrates a network syndicate structure in an embodiment of the system. The syndication network in one embodiment comprises a plurality of syndicate members 101A-101E of FIG. 1. In the example of FIG. 1, each syndicate member 101A-101E is shown as both a publisher and offer provider. However, the syndicate members may be one or the other. For example, a syndicate member may be solely a publisher and rely on others to generate offers that may be published by the publisher.

In other instances, the syndicate member may be solely an offer provider who relies on publishers to disseminate its offers. In addition, there may be third party offer providers 107 that are not necessarily part of the syndicate, but whose offers may be used by the syndicate and introduced by the syndicate management. Further, any syndicate member may introduce an offer from a third party source to the network.

The syndicate members are in communication with campaign management 102. Campaign management 102 is used to maximize campaign effectiveness through monitoring of a campaign to evaluate effectiveness of offers. This monitoring can take place in near real-time or on any desired schedule, so that the system becomes a close looped system that provides accountability to the offer campaign.

As can be appreciated, campaign management is applicable to various advertising campaign managers, including, but not limited to, manufacturers, goods and service providers, advertising departments, and advertising agencies. Essentially all kinds of merchants can make use of the invention to promote their particular business.

A syndication engine 104 is coupled to the campaign manager and to the analytics engine 105, commerce module 106, and third party offer providers 107. The syndication engine is used to manage the sharing and distribution of offers in the syndication network and to manage accounting and other relevant data associated with shared offers. The analytics engine 105 is used to analyze the performance of each offer in all media channels in which it may be published, and to provide metrics that can guide future offer selection by the syndicate members. The commerce module 106 is used to handle fulfillment and other transactional requirements associated with the offers in the syndication network.

Analytics System

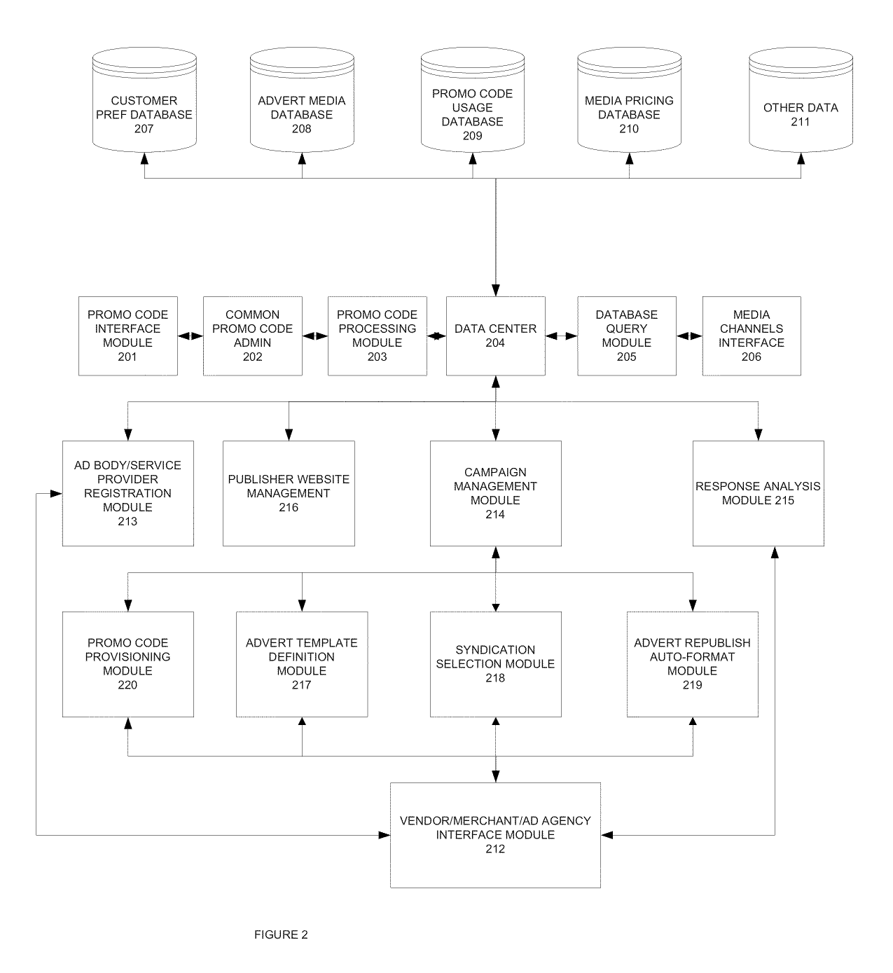

In one embodiment, the system is used as part of an analytics system such as is described in U.S. Pat. No. 8,090,613 which is incorporated by reference herein in its entirety. Such a system allows the modification of campaigns during the life of the campaign to optimize the effectiveness of the campaign. An example of such a dynamic analytics system is illustrated in FIG. 2. FIG. 2 is a block diagram illustrating the promo code embodiment of the system. The embodiment of the system includes a promo code interface module 201, a media channels interface module 202, a vendor/merchant or advertising body user interface module 203, a common promo code administrations interface module 204, a promo code processing module 205, a database query processing module 206, a good or service provider or advertising body registration module 207, an advertising campaign management module 208, a response analysis module 209, a data center 210 including a customer preference database 211, an advert media database 212, a media pricing database 213, and a promo codes usage database 214 among others, a promo code provisioning module 215, and a publisher website 216.

The system may also includes several additional modules, which make new functions possible for the cooperative publishing or syndication of advertisements. These include advert template definition capture module 217, which assists the overall system operator to collect essential information from merchants to be contained in their advertisement and associated special offer, syndication selection interface 218, which allows a source publisher to set parameters for other publishers that intend to syndicate the advertisement, and advert republish auto-format module 219, which allows any member publisher in the network to selected offers to republish the on their website and promote using their own traditional media channels.

The present disclosure describes various embodiments of a system and method for improved advertising using embedded surveys and ad monitoring, analytical analysis of ad effectiveness, all followed by improved performance feedback and especially centralized means to manage and control and to optimize the advertising campaign. In all its various embodiments the system can perform control of advertisement placement and scheduling for maximum efficiency of an off-line and/or on-line campaign while minimizing required efforts from a campaign manager. The system can be implemented within a single computer or be distributed over a number of devices.

It is appreciated that the modules and data structures shown may be combined and/or further partitioned to similarly perform campaign management. Various embodiments of campaign management and optimization methods and systems include alternative implementations and combinations of the above described elements as will be described in more detail below.

The vendor/merchant or advertising body user interface module 213 serves for configuration, and control of operation and display of the system. The advertising body user interface module 213 is used to provide input to a good or service provider or an advertising body registration module 213, an advertising campaign management module 214, and a response analysis module 214 (it should be noted that the response analysis module may also perform in real-time, near-real time, or in some other asynchronous manner where responses are received after offers are run and the system is able to associate responses to particular off-line channels as well as to particular time periods of ad presentation) These modules operate and interact with the central registry of information contained within data center 204. The data center 204 comprises a customer preference database 207, an advert media database 208, a media pricing database 210, a promo code usage database 209, and other database 211, among other databases.

The data in the customer preference database 207 is created in part by interactive collection from a customer that responds to offers and/or registers with one or more of the syndicate members. Additional information in the customer preference database 207 is accumulated over time using the system and tracking usage and response patterns of customers. This data is formed by the cumulative history of responses to offers.

The system of the present disclosure makes it convenient for the advertiser and/or publisher to provide offers to customers in order to increase the likelihood of their conversion. Conversion is the process by which a viewer purchases or subscribes to an advertiser's product or service. The word conversion describes how an advertiser might first encounter a viewer as a sales lead and then the lead would “convert” to becoming a customer by buying a product.

Creative advertisement or creative is a term used to describe the advertisement being used to promote or sell a product or service. The creative or advert media database 208 contains actual viewable or listenable content. The media database 208 content includes digital copies of the offers which will be published in a magazine, newspaper, or even roadside billboard displays, including the Apps that may be associated with the offer (or be the entire offer in some circumstances). It also includes sound files in a digital format such as way, or mp3 files for play on radio commercials. Multi-media ads created for example for broadcast television, cable TV, and viewing in theaters before movies, can be stored in a number of formats in the digital database including among others, divx, avi, mpeg4, mpg, and wmv type files. The system uses the files stored in the media database to allow quick creative review by decision makers while using the analytical information to adjust the scheduling and geographical distribution of ads. The easy and organized access to review capability while simultaneously reviewing the performance data will allow creative design and also management teams, when collaborating on overall advertising strategies or adjusting demographic targets, to better predict the way to design an ad or position it in the marketplace to get the highest performance.

Media buy refers to the buying of advertising space from a company operating media properties such as TV, radio, newspapers, magazines and billboards or outdoor kiosks. The cost of a media buy varies depending on (1) the specific media property on which the buyer wants to advertise, (2) the size of the advertising campaign, (3) the specific times at which the advertisements are to be displayed, and (4) other specific features of the advertising campaign. The media pricing database 210 is built by entering pricing information either manually or automatically collected from the various media channels. Each media channel can have different means for calculating their pricing of an advertisement. Magazines for example run on a monthly basis and charge prices depending on ad size and position. Television commercial prices depend on length, time of day, and are related to the popularity of the show or program during which the spot is aired. The pricing database 210 contains all rules and formulas necessary to make complete price calculations for each media channel, and upon campaign configuration by the operator or user, is used to calculate the total cost for each particular ad included in the campaign along with overall campaign cost.

In one embodiment, the customer will be provided with what is termed here a “promo code”. In one embodiment, promo codes are to be used by the customer at web sites, such as advertiser or publisher web sites. The web site can be accessed by any web enabled device, including computers, PDA's, web enabled cell phones, Smart-Phones, and the like. In implementing a promo code, the publisher of the advert provides a website to which the viewer is invited to navigate. This web site may be a web site of the publisher, of the provider of the goods or services being advertised, or by a third party that implements the system on behalf of participating parties. Once at the web site, the customers will be directed or linked to a promotions web page which solicits the login of the user. Then, upon entry of the promo code the customer has full access to the offered special promotions. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

The promo code usage database 209 contains a complete and current history of which promo codes are assigned to each vendor and offer. This provisioning information is used to prevent duplication of assignment and also permit accurate analysis of the viewer or customer responses.

A media interface module 206 makes communication possible with all the various media channels in order to automatically perform various functions including, among others, gathering the pricing information from the disparate channels. In a preferred embodiment, update of pricing information is an automated process whereby media channels send any changes in pricing as they are made directly to the media interface 206 to the system

A database query processing module 205 is shown in FIG. 2 as gathering data from the media channels for storage in the system. The query processing module 205 also performs all queries that are necessary to create an ad campaign or to assist in the response monitoring and analysis. A promo code interface module 201 provides the ability to capture the customer responses including among others, text messages and keywords sent in response to a particular short code in an advertisement. A promo code processing module 203 takes the captured text messages and keywords and enters them into the appropriate fields in the customer preference database 207 and other databases contained in the system that are necessary to keep track of the volume, timing, and location of each customer response and permit the accurate combined analysis of all the received customer responses.

A campaign management module 214 comprises a number of submodules including a promo code provisioning module 220, an advert template definition module 217, a syndication selection module 218, and advert republish and autoformat module 219.

Daily Deal with App

In the description herein, an offer is a means to draw a response from a consumer of the offer. Such offers can include, but are not limited to, advertisements, discounts, coupons, membership points, access to events or services, and the like. One type of offer that can be used in the present system is known as a “Daily Deal” (DD). Often a DD will require that the consumer purchase the DD offer, typically at a meaningful discount, in return for goods or services valued at greater than the amount paid for the DD. The behavior of the customer in purchasing the DD allows not only accountability for the effectiveness of offers, but immediate financial benefit to the merchant and publisher as well.

An example of a DD is the offer of a coupon that is worth, for example, $50.00 when used at a particular merchant for goods or services. However, the customer only pays, for example, $25.00 for the coupon. When the customer redeems the coupon by using it at the merchant, it is as if the customer gets $50.00 worth of goods or services for only $25.00.

Each offer has associated with it a plurality of metrics and meta-data that allows network members to determine the value of the offer to themselves. For example, if the offer is a DD, the meta-data would include deal terms for using the offer (e.g. the cost to the consumer to purchase the DD, the amount that goes to the provider of the goods or services associated with the DD, the amount that goes to the publisher of the DD, and the amount that goes to the syndication network member that originally offered the DD to the network). Other meta-data may include the historical conversion rate of the offer, the demographics of purchasers of the offer, the conversion rate of the offer per publishing platform (e.g. for radio, television, print, on-line, and the like). The meta-data could also include temporal related data if the performance of the offer has historically had a temporal based correlation or relationship.

Each offer includes a customizable Call-To-Action (CTA) that allows the consumer to respond to the offer (e.g by purchasing the DD). Because each publisher has its own associated CTA, the system can track the identity of the publisher of the offer to which a consumer is responding. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

In the present system, a DD includes and/or require an associated App. In one embodiment, the App is provided by the same merchant who is offering the DD. In another embodiment, the App may be un related to the offering merchant.

Deal Offer to Syndicate

In one embodiment, consider the situation where a merchant proposes a daily deal and App DD/App with a publisher who is a member of the syndicate. The analytics system may be used to generate one or more ad templates for the campaign, including print, television, radio, on-line, and other media. The DD/App is then made available to the syndicate members. The use of templates allows the system to meet the display needs of any of the publishers in the syndicate, whatever media they may choose. One or more publishers in the syndication network may then choose to participate in that DD/APP and publish it themselves. This may be when the publisher does not have its own daily deal for that day or may believe that the source publisher has a better DD/APP than the network publisher has available. The system also allows local publishers (and merchants) to have national exposure opportunities when the DD/APP is used by other syndicate members. It should be noted, that although a Daily Deal is used in this example, the system applies to any offer, whether a Daily Deal or not.

By sharing a DD/APP in a syndicate, each DD/APP can generate greater revenue than if it were limited to a single publisher. In addition, by providing both on-line and off-line publishing opportunities, the system creates exposure to customers that would otherwise be unreachable. The system provides a variety of economic models associated with each DD/APP. For example, a syndicate member who takes the DD/APP may receive a certain revenue share of the DD/APP for all sales. In other embodiments, the syndicate member is offered a revenue share for only those customers that respond to the offer in that members publication. In other instances, the publisher may receive accelerator payments if a certain number of the DD/APP are converted or sold.

Because the system provides for unique promo codes and calls-to-action for each publisher, the system has the ability to provide accurate accounting of revenue sharing and DD/APP performance. In addition, because the download of an App typically requires registration, additional customer and metadata is available through each completed transaction. The analytics system also provides the ability to capture and generate meaningful metrics associated with any individual DD/APP as well as entire categories of DD/APPs so that syndicate members can use the marketplace of DD/APPs more effectively. It should be noted that any individual publisher may themselves have one or more on-line and off-line media in which to publish the DD/APP. The publisher can choose the appropriate template for each publishing platform. In other cases, the publisher may choose a different DD/APP for each publishing platform based on associated metrics of the DD/APP.

Offer With App

FIG. 3 is a flow diagram illustrating the distribution of an App in an embodiment of the system. At step 301 a merchant develops a DD with an associated App. The App in one embodiment is required to redeem or acquire the DD/App. A user who already has the App may also be able to redeem or acquire the DD using the existing App. At step 302 the merchant defines the publishing platforms of interest (e.g. online, offline, magazine, print, radio, TV, newspaper, and the like).

At Step 303 the merchant provides revenue sharing information about the DD/App. This may comprise straightforward payment for some type of conversion of the DD, payment for advertising space regardless of conversion rate, and/or some revenue sharing arrangement based on the performance of the offer. Such revenue sharing can be stepped, where different rates apply for different levels of success of the offer. There may be a different revenue sharing arrangement for each publishing platform if desired.

At step 304 one or more publishers accept the DD/App and publish the DD/App in one or more publishing platforms as step 305. As noted above, each publishing platform will have its own associated CTA so that the system can identify the correct publishing platform to which the user is responding.

Offer Acceptance

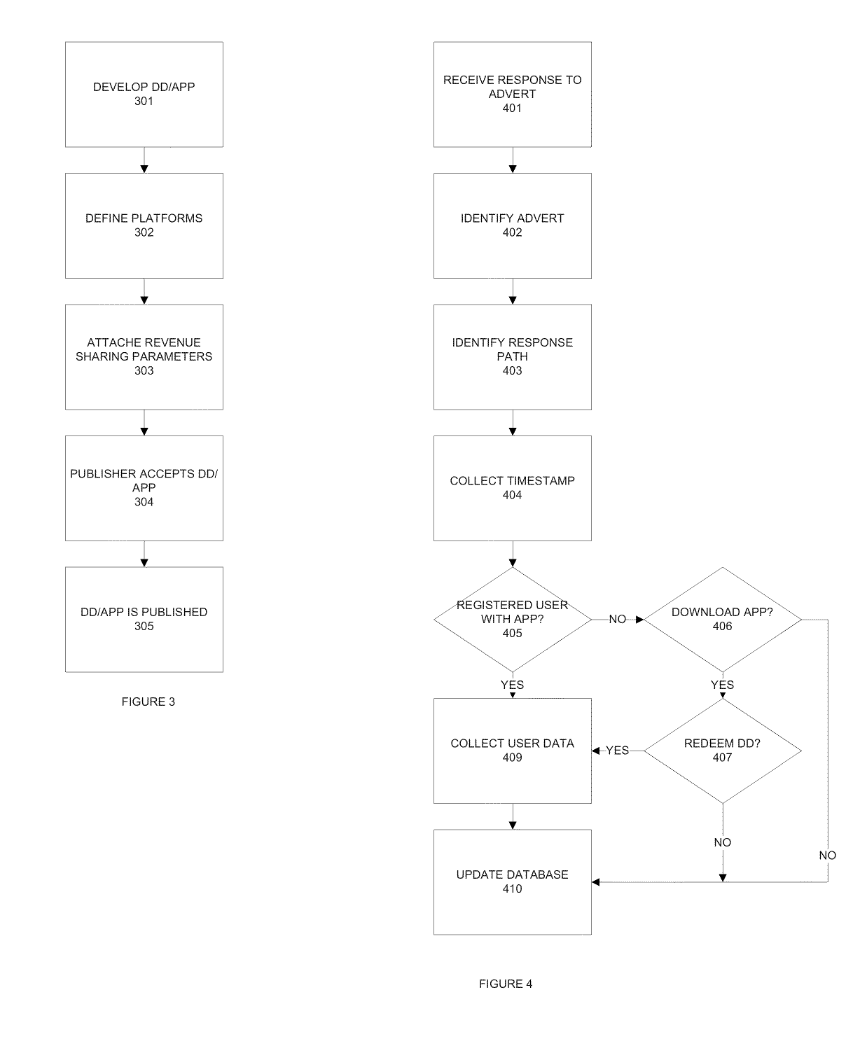

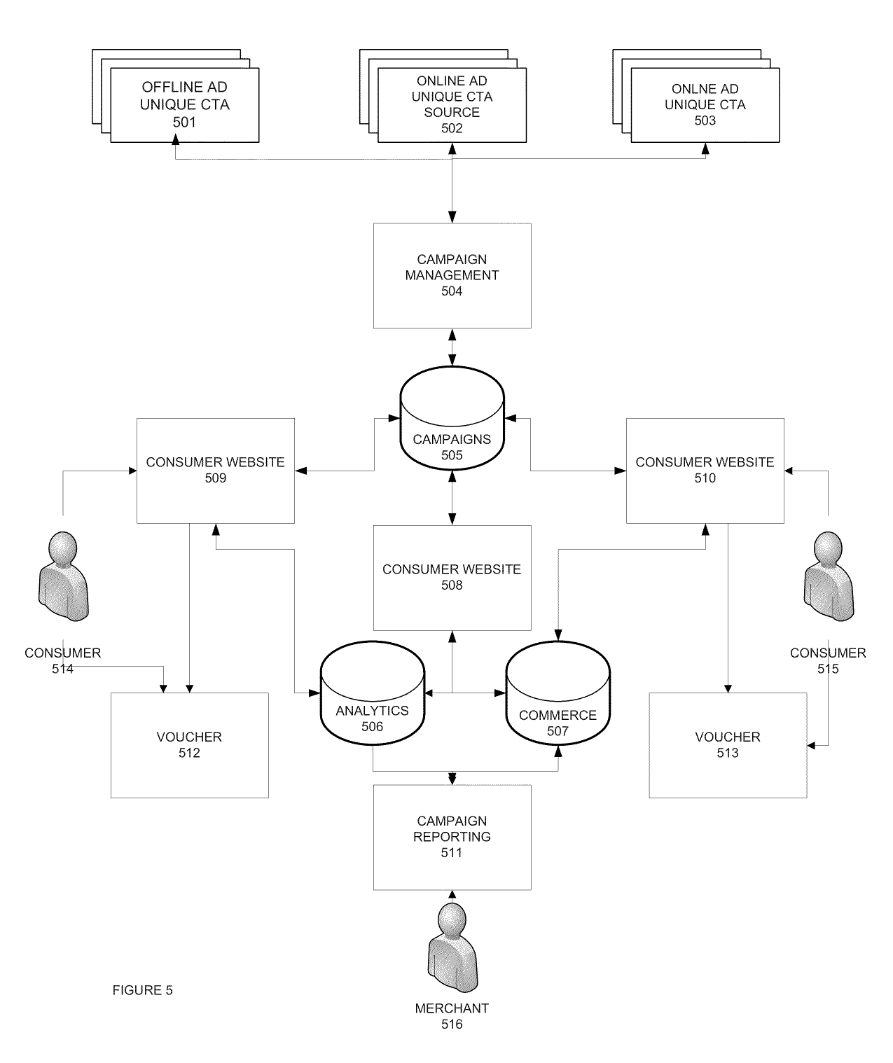

FIG. 4 is a flow diagram illustrating the operation of the campaign management when a consumer responds to an DD/App. It should be noted that the response does not need to be a purchase. There are many levels of response that are of interest to the merchant, publishers and other syndicate members, including visiting the website via the CTA, download of the App and registration without purchase, non-purchase activity on the website (reviewing other deals, clicking on ads, and the like) and registration with purchase.

At step 401 the system receives a response to the DD/App from a user. At step 402 the system analyzes the response to determine the offer to which the consumer is responding. As noted above, this can be via decoding the CTA that is used by the consumer to consummate the response. At step 403 the system identifies the response path. This can be via cell phone, voice mail, messaging, email, web site, social media, and the like. At step 404 the system collects the time stamp information of the response. This allows the system to analyze how quickly the consumer has responded to the offer, which is one gauge of the effectiveness of the advert.

At decision block 405 the system determines if the user is a registered user, meaning the user already has the App and is using it to access the DD. If not, the system proceeds to decision block 404 and offers the App to the user. If the user downloads the App at step 406, the system proceeds to step 407 to determine if the consumer is redeeming the DD. If so, the system proceeds to step 409 and collects the user data associated with the user. After step 409, or if the user does not redeem the offer at step 407, the system updates the database with all available information at step 410.

Offer Metrics

One of the advantages of the system is the useful data that can be accumulated over time with respect to the plurality of offers. Some of the metrics that might be associated with the DD include, but are not limited to, the following:

(1) Cost per Click (CPC) for media spend on the DD. (2) Cost per Click for mobile text messages. The cost per click for mobile text messages is the cost per text message sent by the advertiser plus the cost for receiving the text message divided by the number of unique viewer clicks. Cost for receipt of message is included in this calculation because carriers charge for messages both sent and received. (3) Clicks or viewers per key word. Each keyword placed in an advertisement will receive a certain number of clicks from viewers.

(4) Clicks or viewers per key word by geographic region, (5) Clicks or viewers per key word by market segment such as health care, beauty, travel, and entertainment among others, (6) Clicks or viewers by key word by market and submarket segment such as beauty, luxury or hotels, economy, (7) Clicks or viewers by keyword and demographic profile such as area code, associated zip code, inferred median income, (8) CPC score based upon target market segment, (9) Percentage of target audience reached based upon last previous click, (10) Percentage of target audience reached based upon previous 100 clicks, (11) Percentage of target audience reached based upon entire click history, (12) CPC for one media campaign versus any other media campaign contained within the system. (13) A/B reporting CPC and number of viewers between two similar campaigns using identical keywords to determine ad effectiveness and overall value of one advertisement versus another advertisement, (14) Coefficient correlation or efficiency between many different campaigns but in the same market segment. (15) Coefficient correlation or efficiency of two similar campaigns determined by identical market segment where viewers clicked on both campaigns. (16) Demographics of expected responders (based on historical data). (17) Expected gross return for DD per publishing platform and per access platform. (18) Expected registration rate. (19) E-mail registration traffic. (20) Searches based on link access.

Campaign Management

FIG. 5 illustrates the operation of a DD/App transaction in one embodiment of the system. In this example a merchant 516 has created a DD/App and provided it to source publisher 502. The source publisher has made the DD/App available to the network with attached media spsend and publishers 501 and 503 have elected to publish the DD/App. In this example publisher 501 is an offline publisher while publishers 502 and 503 are online publishers. However, it is possible that each publisher has one or more online and/or offline publishing platforms for offering the DD/App.

Each of the publishers presents the DD/App as an offer with a unique CTA that allows the system to identify the publisher and the platform to which a customer (e.g. consumer 514 or consumer 515) is responding. The publishers are coupled to the system through the campaign management module 504 to the campaigns database 505. Although only a few publishers are shown in FIG. 5, the system is fully scalable and may manage any number of offers as well as any number of publishers who elect to participate in the system.

When consumer 514 elects to purchase the DD/App, the unique CTA directs the consumer to a consumer website 509 that is used for downloading the App, accepting payment and for providing some indicia (e.g. voucher 512) that is used by the consumer 514 for fulfillment of the offer with merchant 516. In some cases, the website may be the website of the publisher, or an associated website. The advantage of directing the consumer 514 to a unique instance of a website is that the publisher can acquire the customer via a required registration process during the voucher transaction. For example, if publisher 501 is a newspaper, the consumer may be required to register with the newspaper as part of the voucher acquisition process. Similarly, consumer 515 is directed to consumer website 510 (perhaps associated with or owned by publisher 503) to purchase voucher 513.

Even if the consumer is already a registered customer of the publisher, the publisher gains valuable demographic data about the customer's preferences and purchasing habits. In one embodiment, there is not only a unique CTA for each publisher and each platform, but for each type of device on which the DD/App appears. For example, Publisher 503 will have a unique CTA for the DD/App when it appears on the publishers mobile platform, tablet platform, or desktop platform. This provides additional unique information about the consumer and about the efficacy of the DD/App and other promotions.

Information about the voucher transactions, from any website, are forwarded to the analytics engine 506 and commerce module 507. Analytics 506 is used to evaluate the effectiveness of the offer and to determine if changes should be made to the campaign, either during the campaign itself, or in future campaigns. The commerce module 507 is used to aid in handling the financial aspects of the voucher transactions, as well as providing accounting and payments to the source publisher and receiving publisher for syndicated offers, as well as to the merchant 516. The system allocates revenue based on the offered parameters and based on adoption rate of the App. The campaign reporting module 511 provides offer statistics to the merchant who will provide the goods and/or services associated with the DD/App and the attached media spend.

Embodiment of Computer Execution Environment (Hardware)

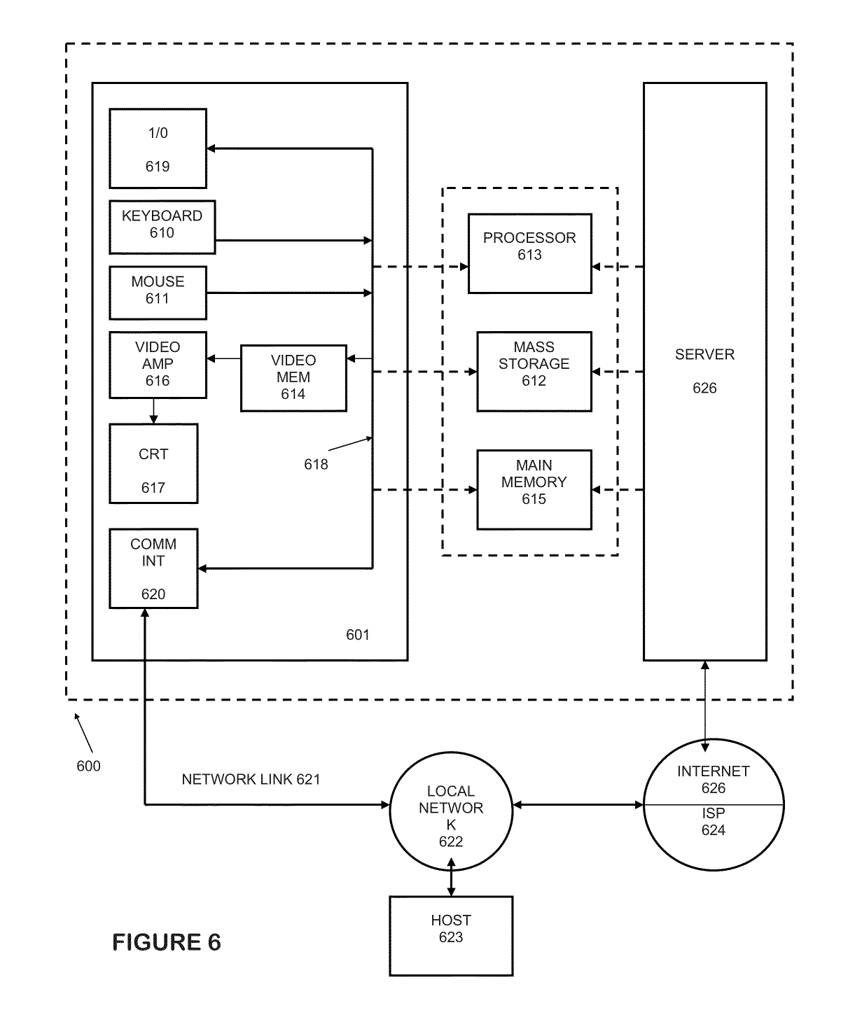

An embodiment of the system can be implemented as computer software in the form of computer readable program code executed in a general purpose computing environment such as environment 600 illustrated in FIG. 6, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 610 and mouse 611 are coupled to a system bus 618. The keyboard and mouse are for introducing user input to the computer system and communicating that user input to central processing unit (CPU 613. Other suitable input devices may be used in addition to, or in place of, the mouse 611 and keyboard 610. I/O (input/output) unit 619 coupled to bi-directional system bus 618 represents such I/O elements as a printer, A/V (audio/video) I/O, etc.

Computer 601 may include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Wireless links are also possible. In any such implementation, communication interface 620 sends and receives electrical, electromagnetic or optical signals which carry digital data streams representing various types of information.

Network link 621 typically provides data communication through one or more networks to other data devices. For example, network link 621 may provide a connection through local network 622 to local server computer 623 or to data equipment operated by ISP 624. ISP 624 in turn provides data communication services through the world wide packet data communication network now commonly referred to as the “Internet” 626 Local network 622 and Internet 626 both use electrical, electromagnetic or optical signals which carry digital data streams. The signals through the various networks and the signals on network link 621 and through communication interface 620, which carry the digital data to and from computer 600, are exemplary forms of carrier waves transporting the information.

Processor 613 may reside wholly on client computer 601 or wholly on server 626 or processor 613 may have its computational power distributed between computer 601 and server 626. The processing functionality can be provided via cloud servers or cloud processing systems. Server 626 symbolically is represented in FIG. 6 as one unit, but server 626 can also be distributed between multiple “tiers”. In one embodiment, server 626 comprises a middle and back tier where application logic executes in the middle tier and persistent data is obtained in the back tier. In the case where processor 613 resides wholly on server 626, the results of the computations performed by processor 613 are transmitted to computer 601 via Internet 626, Internet Service Provider (ISP) 624, local network 622 and communication interface 620. In this way, computer 601 is able to display the results of the computation to a user in the form of output.

Computer 601 includes a video memory 614, main memory 615 and mass storage 612, all coupled to bi-directional system bus 618 along with keyboard 610, mouse 611 and processor 613.

As with processor 613, in various computing environments, main memory 615 and mass storage 612, can reside wholly on server 626 or computer 601, or they may be distributed between the two. Examples of systems where processor 613, main memory 615, and mass storage 612 are distributed between computer 601 and server 626 include thin-client computing architectures and other personal digital assistants, Internet ready cellular phones and other Internet computing devices, and in platform independent computing environments, In other embodiments, memory and/or storage may reside, in whole or in part, in a cloud system.

The mass storage 612 may include both fixed and removable media, such as magnetic, optical or magnetic optical storage systems or any other available mass storage technology. The mass storage may be implemented as a RAID array or any other suitable storage means. Bus 618 may contain, for example, thirty-two address lines for addressing video memory 614 or main memory 615. The system bus 618 also includes, for example, a 32-bit data bus for transferring data between and among the components, such as processor 613, main memory 615, video memory 614 and mass storage 612. Alternatively, multiplex data/address lines may be used instead of separate data and address lines.

In one embodiment of the invention, the processor 613 is a microprocessor such as manufactured by Intel, AMD, Sun, etc. However, any other suitable microprocessor or microcomputer may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the cathode ray tube (CRT) raster monitor 617. Video amplifier 616 is well known in the art and may be implemented by any suitable apparatus. This circuitry converts pixel data stored in video memory 614 to a raster signal suitable for use by monitor 617. Monitor 617 is a type of monitor suitable for displaying graphic images.

Computer 601 can send messages and receive data, including program code, through the network(s), network link 621, and communication interface 620. In the Internet example, remote server computer 626 might transmit a requested code for an application program through Internet 626, ISP 624, local network 622 and communication interface 620. The received code maybe executed by processor 613 as it is received, and/or stored in mass storage 612, or other non-volatile storage for later execution. In this manner, computer 600 may obtain application code in the form of a carrier wave. Alternatively, remote server computer 626 may execute applications using processor 613, and utilize mass storage 612, and/or video memory 615. The results of the execution at server 626 are then transmitted through Internet 626, ISP 624, local network 622 and communication interface 620. In this example, computer 601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. An method of distributing an app comprising:
in a processing system;
associating the app with an offer, wherein the offer includes a call-to-action (CTA) that is unique for each publishing platform and for each response platform;
publishing the offer on a plurality of platforms;
providing a mechanism for downloading the app when a consumer responds to the offer.

2. The method of claim 1 wherein the offer is a daily deal.

3. The method of claim 1 wherein the offer is generated by a merchant.

4. The method of claim 3 where the app is associated with the merchant.

5. The method of claim 4 wherein a publisher provides a generic app platform to the merchant that the merchant can modify to associate the app with the merchant.

6. The method of claim 5 wherein the system provides a pricing structure associated with the distribution of the app.

7. The method of claim 6 wherein the pricing structure is dependent on the publishing platform and the response platform.

8. The method of claim 7 wherein the app includes advertising of the publishing platform on which it was downloaded.

9. The method of claim 8 the purchase pattern behavior of consumers is used to generate the pricing structure.

10. The method of claim 9 wherein a consumer is assigned a different pricing structure for each response platform.
